(19) United States
(12) Patent Application Publication
(10) Pub. No.: US 2010/0314818 A1
(43) Pub. Date: Dec. 16, 2010

(54) CLAMP

(75) Inventor: Paul P. Sweeting, Nottingham (GB)

Correspondence Address: OLIFF & BERRIDGE, PLC, P.O. BOX 320850, ALEXANDRIA, VA, 22320-4850, US

(73) Assignee: ROLLS-ROYCE PLC, London (GB)

(21) Appl. No.: 12/808,372

(22) PCT Filed: Dec. 16, 2008
(86) PCT No.: PCT/GB2008/004133

§ 371 Date: Jun. 16, 2010

(30) Foreign Application Priority Data
Jan. 24, 2008 (GB) 0801285.8

(51) Int. Cl. B25B 5/06

(52) U.S. Cl. 269/254 R

(57) ABSTRACT

Over tightening of clamps (2) utilised to secure components and frames to machine tables and beds can cause significant problems with regard to damage to the bed or machine table as well as mis-location. By providing a clamp 1 having a pivot 4 and peripheral springs 2, 3 a limitation on clamping force (B) can be achieved. The clamp 1 is formed from sheet materials and incorporates an over centre pivot 4 such that the retainer 5 and in particular head 6 is brought into clamping engagement by the peripheral springs 2, 3 coming into engagement with surfaces about a slot in order to generate the clamping force (B). The peripheral springs 2, 3 come into engagement by rotation about the pivot 4 to provide a progressive clamping action.

The present invention relates to clamps and more particularly clamps for securing components and platforms to machine tables or beds.

It will be appreciated that there is a desire to clamp and secure components and pallets along with other assemblies to machine beds for processing or to pallets for transportation etc. Particularly with regard to aircraft installations and assemblies there is a desire to reduce weight such that relatively thin sheet materials are used. Nevertheless with previous clamping arrangements there is a tendency or culture to over tighten the clamping bolts or mechanism in order to clearly locate a component or a platform. Such over tightening can cause damage to the clamping mechanism along with the component itself, bed or transportation pallet. Such over tightening has particular detrimental effects with regard to less rigid sheet formed structures. It will be understood that the detrimental effects are due to unnecessary forces applied by the clamping bolts etc causing defection of the fixing parts which in turn can affect their accuracy of positioning and functionality. Such damage to and by the clamp arrangement can cause problems if accurate processing is required.

In accordance with aspects of the present invention there is provided a clamp comprising a retainer for association with a slot, the clamp characterised in that the retainer is associated with a pivot having an over-centre action when turned to force engagement of the retainer with a slot, the pivot surrounded by a plurality of spring peripheries to engage about the slot to apply a retentive bias to the retainer towards the pivot.

Typically, the retainer has a T head for engagement with a slot.

Possibly, the clamp has a handle to turn about the pivot.

Generally, the spring peripheries are configured about the pivot. Normally, the spring peripheries are approximately concentric about the pivot. Advantageously, the spring peripheries inter-engage with each other when turned about the pivot to force engagement of the retainer with the slot. Possibly, there are spring gaps between the spring peripheries. Generally, one of the spring peripheries has an engagement end.

Possibly, the spring periphery is provided in a plate. Advantageously, the clamp comprises a plurality of plates in tandem with a spacer between them. Generally, the plates are parallel to each other.

Also in accordance with aspects of the present invention there is provided an arrangement including a clamp as described above and a slot.

Typically the slot is in a surface. Advantageously, the slot has a T section. Generally, the slot has an entry part to provide access for the retainer in use. Typically, the retainer is rotatable in the slot to a location where the retainer engages shoulder portions of the slot.

Possibly, the retainer head incorporates an adjustor for length. Typically, the adjustor comprises a ratchet association between parts of the retainer.

Embodiments of aspects of the present invention will now be described by way of example with reference to the accompanying drawings in which:

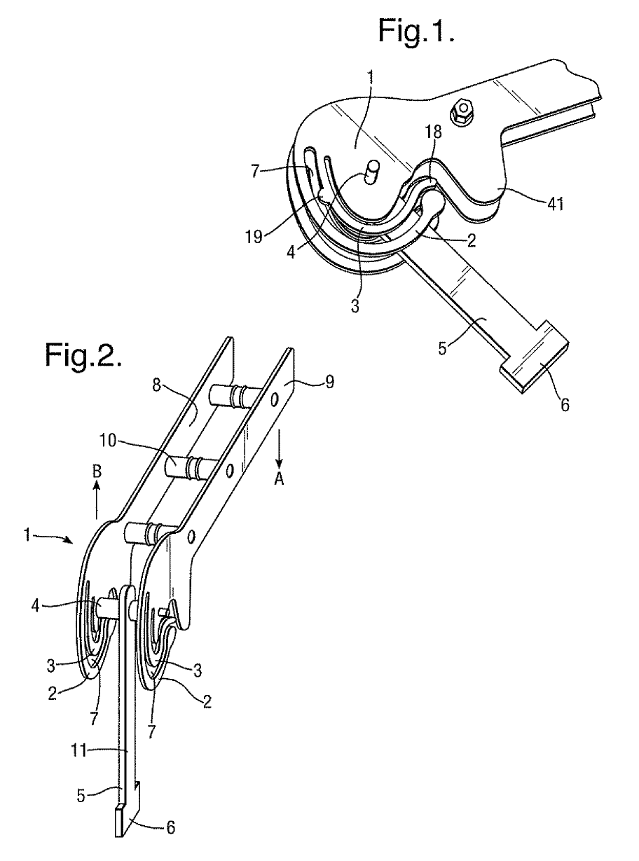

FIG. 1 is a pictorial view of a clamp head in accordance with aspects of the present invention;

FIG. 2 is a perspective schematic view of the clamp head and clamp in accordance with aspects of the present invention as depicted in FIG. 1;

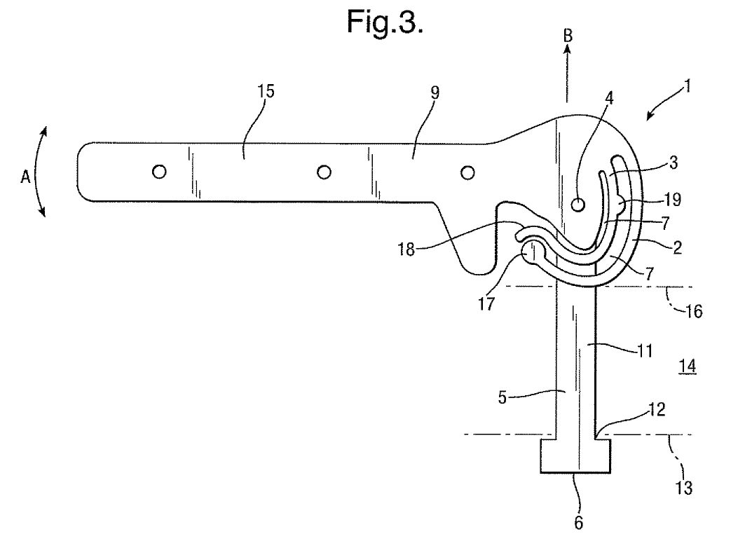

FIG. 3 is a side view of the clamp depicted in FIGS. 1 and 2;

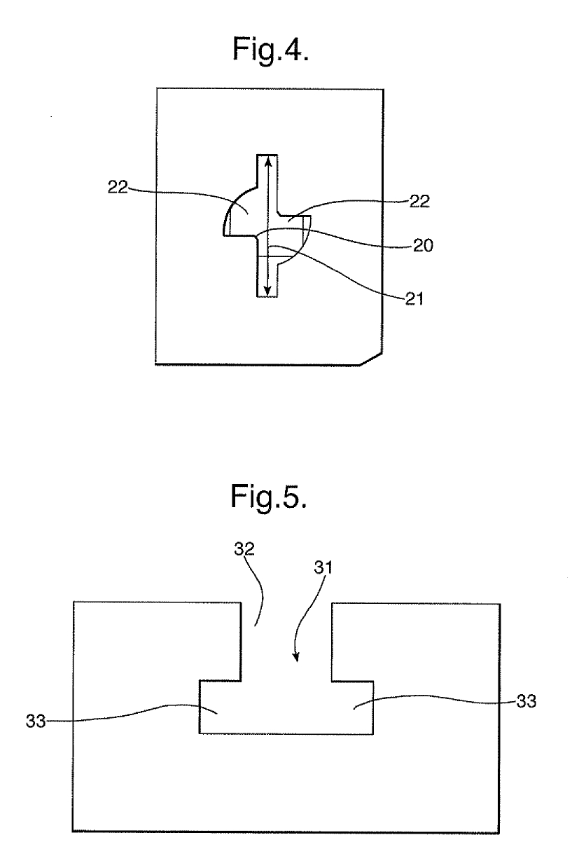

FIG. 4 is a plan view of a slot utilised in the clamp arrangement in accordance with aspects of the present invention;

FIG. 5 is a schematic cross section of the slot depicted in FIG. 4;

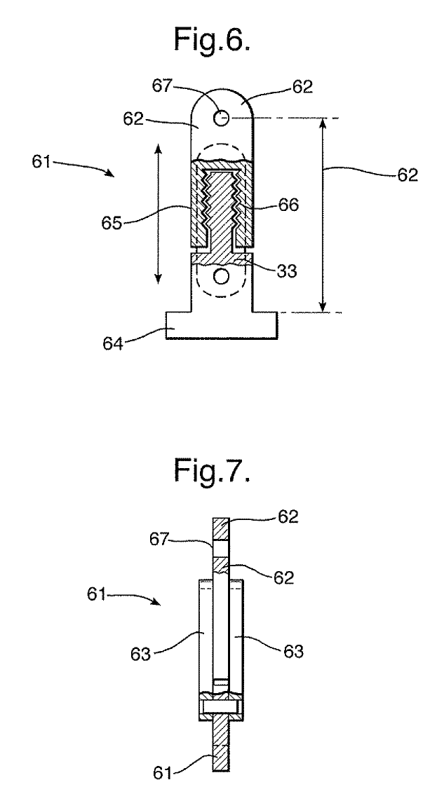

FIG. 6 is a side part cross-section of an adjustable retainer in accordance with aspects of the present invention; and

FIG. 7 is a front view of the retainer depicted in FIG. 6.

As indicated above clamp over tightening can cause severe problems with regard to accurate positioning as well as damage to the clamp and slot within a bed or table upon which the clamp acts. In accordance with aspects of the present invention a clamp retainer is associated with a spring periphery in order to limit the potential applied force.

FIG. 1 provides a pictorial representation of a clamp in accordance with aspects of the present invention. Thus, a plate 1 in the embodiment shown is shaped and cut to define a first spring periphery 2 and a second spring periphery 3 respectively extending about a pivot or fulcrum 4. Generally, there is a spring retainer (not shown) secured upon the fulcrum to retain the clamp and in particular the spring periphery 2, 3 in position. The spring retainers prevent lateral deflection of the spring peripheries during clamping. Extending from the clamp is a retainer 5. The retainer 5 generally is in the shape of a T bar of an appropriate length and with a head. The retainer 5 has a cross section varying in thicknesses for different slot sizes. It will appreciated that a stem portion of the retainer 5 should be able to rotate freely about the pivot 4 and will be dimensioned to allow rotation in a slot from an entry position to a clamp position where there is engagement by a head section 6 with a shoulder portion of the slot (not shown) as described below.

It will be noted that there are gaps 7 between and either side of the springs 2, 3 provides a double action arrangement for the embodiment depicted in FIG. 1. These gaps 7 provide engagement ranges for the peripheral springs 2, 3 which engage each other to progressively apply pressure as the head 6 is drawn into engagement with shoulder portions of a slot in use. It will be appreciated by providing a double spring 2, 3 arrangement a more progressive clamping action is provided with a slot as will be described later.

FIG. 2 provides an illustration of a clamp in accordance with aspects of the present invention. Similar reference numerals have been utilised for comparison. As indicated above clamps in accordance with aspects of the present invention are particularly useful with regard to components formed from sheet materials. In such circumstances the clamp 1 in accordance with aspects of the present invention comprises two plates 8, 9 separated by spacer elements 10. The fulcrum or pivot 4 also acts as a spacer in the clamp 1. Each plate 8, 9 incorporates peripheral springs 2, 3 which as will be described later are arranged to engage about a slot in use in order to provide a progressive clamping action.

As can be seen the retainer 5 extends downwardly from the pivot 4 and is generally centrally located between the plates 8, 9. The retainer 5 has a shape and configuration to engage a slot in use. In such circumstances the head 6 is arranged to engage shoulder portions of the slot in use whilst a stem 11 has a length to extend through the slot for engagement as well as a width to allow rotation in the slot for engagement of the T head 6 with shoulder portions of the slot.

As described previously there is a gap 7 between the peripheral springs 2, 3 to allow the progressive clamping arrangement in accordance with aspects of the present invention. In such circumstances it will be appreciated that the peripheral springs 2, 3 engage either side of the slot and this engagement becomes more effective as the handle is turned in a direction A. By the nature of the peripheral springs 2, 3 engages each other it will be appreciated an upward tension is provided in the direction of arrowhead B for robust location of the retainer 5 in the slot.

FIG. 3 provides a schematic side view of the clamp 1 depicted in FIGS. 1 and 2. The clamp 1 is shown in a locked position. In such circumstances the peripheral springs 2, 3 have inter-engaged in order to provide a clamping action. This clamping action acts through the retainer 5, and in particular the T head 6, engaging a slot 12 formed in a plate 13 as part of a bed or table surface 14. It will be understood as described previously a retentive force is provided in the direction of arrowhead P to retain the clamp 1 between the head 6 on one side of the bed or table 14 and the peripheral springs 2, 3 on the other.

As indicated previously a handle part 15 of the clamp is turned in the direction of arrowheads A about the pivot 4 in order to bring the spring 2 into engagement with an upper surface 16 of the bed or table 14. Thus, in view of the over centred nature of the pivot 4 it will be appreciated that the spring 2 is deflected inwardly in order to provide an initial clamping action through the mechanical bias created in the spring 2 engaging the surface 16 bringing a retention action in the direction of arrowhead B.

An engagement end 17 of the first peripheral spring 2 has a generally bulbous nature. In such circumstances in association with a reciprocal end 18 of the second peripheral spring 3 contact is made in order to deflect that spring 3 in order to provide additional bias for presentation of the retention force in the direction of arrowhead B.

It will be appreciated that the length, size and thickness of the peripheral springs 2, 3 will be chosen in order to create a desired level of retentive force in the direction of arrowhead B. The thickness of the springs 2, 3 as well as the gaps 7 define the level of retentive force in the direction of arrowhead B which can be achieved. In such circumstances there is a limitation upon potential damage to the surfaces 13, 16 about the slot by attempted over tensioning. In such circumstance more predictability and accuracy with regard to retentive forces in the direction of arrowhead B can be achieved ensuring good location of the clamp 1 in use without damaging to the bed or table 14.

FIGS. 4 and 5 provide schematic illustrations of slots utilised in accordance with aspects of the present invention in order to provide retention in a table or bed. As can be seen in FIG. 4 a slot 20 is appropriated shaped to allow entry of the retainer 5 (shown in FIGS. 1 to 3) and to allow that retainer and in particular the head to be turned in use. It will be noted that the slot 20 has an entry width 21 to accommodate the head of the retainer whilst generally sweep portions 22 are provided to define a width for the slot 20 within which the stem 11 can be accommodated whilst the head engages shoulder portions of the aperture or slot 20 either side. In such circumstances the retainer 5 will be positively retained within the slot 20. The head 6 can be made relatively wide for broad engagement with shoulder portions of the slot 20 whilst an adequate thickness for the stem 11 can be provided through the sweep portions 22. As indicated clamps in accordance with aspects of the present invention are particularly advantageously formed from sheet material and therefore the capability of providing a wide stem 11 as well as head 6 will ensure robust structural strength despite a sheet based nature.

FIG. 5 provides a depth cross section of a possible slot 31 utilised in accordance with a clamp arrangement of aspects of the present invention. The slot 31 generally has a T cross section including an entry portion 32 to allow the retainer 5 to enter the slot 31. The bottom part of the slot 31 includes T or lateral portions 33 which will engage the head 6 of the retainer 5 in accordance with aspects of the present invention.

Generally, FIG. 4 shows a shape cut into a fixture/tool to be clamped whilst FIG. 5 shows a cross-section of a typical machine bed/table. The shape of the aperture in FIG. 4 allows the retainer to pass through it into the “T” section of the machine bed/table depicted in FIG. 5.

Slots 21, 31 are formed in a machine bed or table to allow a clamp in accordance with aspects of the present invention to be located and secured. It will be understood that within a bed or table a slot in accordance with aspects of the present invention will be cut at every position where clamping may be required. The retainer will pass through a slot in the component or pallet to be secured and then into a slot in the bed of a machining table etc.

In terms of operation it will be appreciated that initially the clamp 1 in accordance with aspects of the present invention will be presented to a slot such that the retainer passes through that slot either completely to the other side or into a trench like slot as depicted in FIG. 5 or both to provide retention of a component with slot on a base with trench slot. Once the entry portion has passed through the slot or is in position within the trench it will be appreciated that the retainer and in particular the head of the retainer will be rotated to engage a slot and in particular shoulder portions of that slot. This rotation will generally occur with the handle 15 substantially perpendicular and in line with the retainer and therefore the slot. Rotation will generally be in the order of 90 degrees.

The stem 11 of the retainer 5 will be chosen to have a length appropriate for the depth of the slot in accordance with aspects of the present invention. In such circumstances the head 6 will be relatively closely adjacent or have a controlled spacing from shoulder portions of the slot. Once the retainer is rotated such that the head is appropriately presented to shoulder portions of the slot it will be appreciated that the progressive clamping force in accordance with aspects of the present invention will be applied. This force will be achieved through moving the handle 15 from a substantially vertical orientation to a horizontal orientation in the direction of arrowhead A as described previously above. Such movement ensures engagement between the peripheral springs 2, 3 and through an over centre pivot action resulting in a locking function by a bias in the direction of arrowhead B caused by engagement of the springs 2, 3 with the surface 16 (shown in FIG. 3). Once the handle has reached a horizontal orientation it will be understood that further rotational will be inhibited by engagement with the surface 16. However, and in any event generally as depicted in FIG. 1, a foot portion 41 will be provided to initially contact an upper surface of the retainer bed or table about the slot to prevent further rotation about the pivot 4.

The retention bias is created by distortion of the springs 2, 3 and is therefore effectively limited through the spring engagement with the surface about the slots and inter-engagement between the springs 2, 3 particularly at the ends 17, 18. It will be appreciated that the springs 2, 3 are secured at one end and extend approximately concentrically about a proportion of the peripheral of the clamp 1 or plate relative to the pivot 4. In such circumstances the springs 2, 3 will deflect and deform in order to create the mechanical stressing for generation of the retentive bias force in the direction of arrowhead B. The relative length of the springs 2, 3 as well as positioning of the ends 17, 18 and the material from which they are formed will all determine the strength of the retentive force B created. It will be noted that generally a spacer element 19 will also be provided in order to ensure appropriate separation to achieve the progressive clamping action in accordance with aspects of the present invention.

As indicated above a progressive clamping action with a double spring arrangement is illustrated in the attached drawings. In such circumstances there will be an initial easy movement to cause retention by the first spring 2 engaging the surface 16 in order to raise the retainer 5 in the direction of arrowhead B such that the head 6 engages part of the slot 13. Once the engagement end 17 engages the reciprocal end 18 it will then be understood that that first spring 2 reacts with the second spring 3 to provide a more positive clamping force in the direction of arrowhead B. Once the handle 15 is at a substantially horizontal orientation a final clamping pressure is generated through engagement of the head 6 upon the surface 13 and the outer spring 2 with the surface 16. The springs 2, 3 define and create the clamping force in the direction of arrowhead B.

As indicated above generally at least a double peripheral spring 2, 3 configuration is desirable in order to achieve a progressive clamping force. However, it will also be understood that a single peripheral spring may be utilised with a progressive increase in force as the spring is further deflected until a final engagement with stable parts of the clamp in accordance with aspects of the present invention. Furthermore, triple or more peripheral springs may be created which upon deformation inter-engage with each other in order to achieve progressive increase in engagement and so clamping force in direction of the arrowhead B in accordance with aspects of the present invention and therefore more sympathetic clamping action.

It will be appreciated that clamps in accordance with aspects of the present invention allow greater accuracy and repeatability with regard to clamping loads irrespective of the strength of an operator or their aggressiveness. It will also be understood that through changes in the retainer and in particular the size of the head and stem, different sizes and ranges of slots can be associated with a clamp in accordance with aspects of the present invention. Furthermore, it will be understood that different gauges of sheet material can be utilised in order to create the clamp in accordance with aspects of the present invention. Furthermore, where the thickness of sheet material cannot be accommodated in order to achieve the desired nature for the peripheral spring required it will be possible in such circumstances to provide retainer elements having different lengths to limit the compressive force or provide step changes in the length of the T bar retainer for different requirements.

Clamps in accordance with aspects of the present invention as indicated can be simply constructed from sheet materials cut appropriately to define the functional elements and in particular the peripheral spring parts. Furthermore, the clamp is integral in that the clamp can simply be associated with a slot in a bed or table without a requirement for additional tools. Clamping force is limited by the peripheral springs and therefore overzealous clamping is avoided. It will also be understood that design and construction for special requirements is relatively easy. Furthermore the clamp is quick and easy to use and also relatively cheap to manufacture. It will also be understood that being formed from sheet material it is possible to create specific clamps for particular requirements within a relatively short time period.

As indicated above generally the retainer can have a step change in its length to accommodate for different thicknesses in the material as well as slot dimensions. It will also be understood that a set of different length retainer bars could be provided with a quick change mechanism about the pivot in accordance with aspects of the present invention. A quick change pivot may comprise a hook upon which a retainer having a T bar at the other end is simply attached to allow simply changing in use.

Generally, clamps in accordance with aspects of the present invention will be formed from a sheet metal material. However, parts of the clamp at least may be formed from a sheet plastic material with appropriate mechanical strength in order to achieve the desired operational performance. In particular, the retainer may be formed from a plastic material for sympathetic engagement with a slot in an arrangement in accordance with aspects of the present invention.

It will be appreciated in some circumstances variation in the length of the retainer utilised in accordance with aspects of the present invention would be advantageous. Furthermore, provision within the retainer of a limitation with regard to clamping pressure may be advantageous. FIGS. 6 and 7 illustrate a means of adjusting length and for providing clamping pressure limitation for retainer 61 in accordance with aspects of the present invention.

Retainer 61 comprises an upper part 62 secured to the fulcrum or pivot (not shown) of the clamping arrangement and a lower part 63 associated with a retainer head 64. Association between the parts 62, 63 is through an adjuster comprising opposed ratchet teeth 65, 66 in the respective parts 62, 63. In such circumstances the length from a pivot location position 67 to the head 64 illustrated by arrowhead 68 (FIG. 6) can be adjusted in accordance with requirements. In such circumstances varying clamping distances can be provided without the need to produce retainers of different lengths. Alternatively, or additionally, through the ratchet association 65, 66 it will be appreciated that the clamping pressure provided by the head in accordance with aspects of the present invention may be limited to the strength of the association between the ratchets 65, 66 of the adjuster in accordance with aspects of the present invention.

1. A clamp (1) comprising a retainer (5) for association with a slot (12, 20, 31), the clamp characterized in that the retainer is associated with a pivot (4) having an over-centre action when turned (A) to force engagement of the retainer with a slot, the pivot surrounded by a spring periphery (2, 3) to engage about the slot to apply a retentive bias (B) to the retainer towards the pivot.

2. A clamp as claimed in claim 1 wherein the retainer has a T head (6) for engagement with a slot.

3. A clamp as claimed in claim 1 or claim 2 wherein the clamp has a handle (15) to turn about the pivot.

4. A clamp as claimed in any of claims 1 to 3 wherein there is a plurality of spring peripheries.

5. A clamp as claimed in claim 4 wherein the spring peripheries are configured about the pivot.

6. A clamp as claimed in claim 4 or claim 5 wherein the spring peripheries are approximately concentric about the pivot.

7. A clamp as claimed in any of claims 4 to 6 wherein the spring peripheries inter-engage with each other when turned about the pivot to force engagement of the retainer with the slot.

8. A clamp as claimed in any of claims 4 to 7 wherein there are spring gaps (7) between the spring peripheries.

9. A clamp as claimed in any preceding claim wherein the spring periphery has an engagement end (17).

10. A clamp as claimed in any preceding claim wherein the spring periphery is provided in a plate (8, 9).

11. A clamp as claimed in claim 10 wherein the clamp comprises a plurality of plates in tandem with a spacer (10) between them.

12. A clamp as claimed in claim 11 wherein the plates are parallel to each other.

13. A clamp substantially as hereinbefore described with reference to the accompanying drawings.

14. A clamp arrangement including a clamp (1) as claimed in any preceding claim and a slot.

15. An arrangement as claimed in claim 14 wherein the slot is in a surface (16).

16. An arrangement as claimed in claim 14 or claim 15 wherein the slot has a T section.

17. An arrangement as claimed in any of claims 14 to 16 wherein the slot has an entry part (21, 32) to provide access for the retainer in use.

18. An arrangement as claimed in any of claims 14 to 17 wherein the retainer is rotatable in the slot to a location where the retainer engages shoulder portions of the slot.

19. An arrangement as claimed in any preceding claim wherein the retainer includes an adjustor to vary adjuster length.

20. An arrangement as claimed in claim 19 wherein the adjuster comprises a ratchet association between parts of the retainer.

21. An arrangements as claimed in any preceding claim wherein the retainer incorporates an adjuster to limit clamping force provided through the retainer.

22. A clamp arrangement substantially as hereinbefore described with reference to the accompanying drawings.
